(19) United States
(12) Patent Application Publication
(10) Pub. No.: US 2005/0112039 A1
(43) Pub. Date: May 26, 2005

(54) Ultraviolet purification system

(76) Inventor: Darren S. Sheehan, West Hartford, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/723,637

(22) Filed: Nov. 26, 2003

(51) Int. Cl. B01J 19/08

(52) U.S. Cl. 422/186.3

(57) ABSTRACT

In a fluid purification system, the same ultraviolet lights are used for both germicidal irradiation and photocatalytic oxidation. By positioning the ultraviolet lights where they can shine on both a heat transfer element (or other air handling system component) and onto a photocatalyst on a substrate, the total number of ultraviolet lights in the system is reduced, thereby reducing both the initial cost and the maintenance cost of periodically replacing the ultraviolet lights.

### BACKGROUND OF THE INVENTION

The present invention relates generally to a fluid purification system and more particularly to an ultraviolet air purification system.

Some currently-known air handling systems utilize ultraviolet lights to irradiate surfaces and/or the fluid stream inside the air handling equipment. The ultraviolet energy kills biological contaminants on the surfaces upon which it shines and in the fluid stream which flows over the lights. For example, some systems shine the ultraviolet light on the evaporator coil, the drain pan under the evaporator coil or sections of the ductwork. This kills biological contaminants that may form in the condensed water on the evaporator coil, in the drain pan or on the duct walls.

Ultraviolet lights are also sometimes used in air-handling systems in photocatalytic oxidation systems. A substrate coated with a photocatalyst, such as TiO₂, is positioned in the fluid stream. The ultraviolet light shining on the photocatalyst produces an oxidation process that removes many gases and chemicals, such as volatile organic compounds, from the air.

In both systems, the ultraviolet light sources are expensive. Additionally, the ultraviolet light sources must be replaced periodically, thereby increasing the cost of both of the systems.

### SUMMARY OF THE INVENTION

In the present invention, the same ultraviolet lights are used for both germicidal irradiation and photocatalytic oxidation. By positioning the ultraviolet lights where they can direct ultraviolet light onto both the evaporator coil (or other heat transfer element or any other air handling system component) and the photocatalyst, the total number of ultraviolet lights in the system is reduced, thereby reducing both the initial cost and the maintenance cost of periodically replacing the ultraviolet lights. In one embodiment, the ultraviolet lights are positioned such that they direct ultraviolet light onto the evaporator coil, the drain pan, the housing and the photocatalyst on the substrate.

### BRIEF DESCRIPTION OF THE DRAWINGS

Other advantages of the present invention can be understood by reference to the following detailed description when considered in connection with the accompanying drawings wherein:

FIG. 1 is a perspective view, partially broken away, of the ultraviolet purification system of the present invention.

FIG. 2 is a side sectional view of the ultraviolet purification system of FIG. 1.

### DETAILED DESCRIPTION OF THE PREFERRED EMBODIMENTS

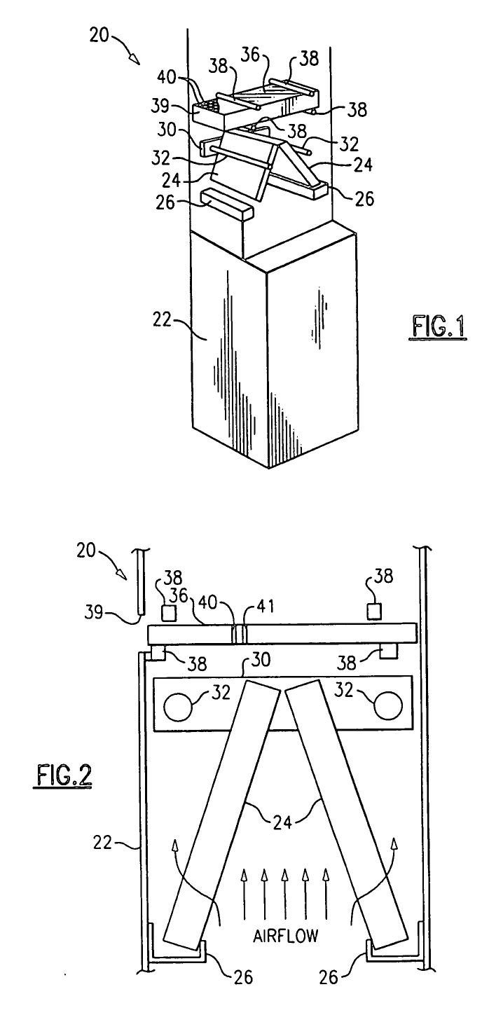

An ultraviolet fluid purification system 20 is shown in FIG. 1. The system 20 includes a housing 22 directing a fluid stream flowing therein. In the fluid stream is positioned one or more fluid handling components, such as a pair of evaporator coils 24 below which are positioned one or more drain pans 26. An ultraviolet irradiation system 30 includes a pair of ultraviolet light sources 32, each positioned just downstream of one of the evaporator coils 24. A substrate 36, such as a metal honeycomb substrate, is positioned downstream of the ultraviolet light sources 32. The substrate 36 is supported by a media cabinet including supports 38 aligned with an opening 39 in the housing 22. The substrate 36 may include a plurality of apertures 40 passing through the substrate. In a preferred embodiment, the ultraviolet light sources 32 are cylindrical and direct light radially outwardly.

As shown in FIG. 2, the substrate 36 includes a photocatalyst 41 on at least one surface of the substrate 36. Preferably, the substrate 36 is a honeycomb structure having many apertures 40 (one shown in FIG. 2) with many interior surfaces coated with the photocatalyst 41 and the fluid stream passes through the honeycomb structure adjacent the photocatalyst 41.

Referring to FIG. 2, in operation, the ultraviolet light sources 32 direct ultraviolet light radially outwardly, upstream onto the evaporator coils 24 and the drain pans 26, downstream onto the photocatalyst 41 on the substrate 36 and onto the interior surfaces of the housing 22. The ultraviolet light prevents or kills biological contaminants that would otherwise form on the evaporator coils 24, the drain pans 26 or the interior surfaces of the housing 22. At the same time, the ultraviolet light is directed onto the photocatalyt 41 on the substrate 36, thereby removing gases and chemicals, including volatile organic compounds, from the fluid stream.

Because the same ultraviolet lights are used for both germicidal irradiation and photocatalytic oxidation, the total number of ultraviolet lights 32 in the system is reduced. This reduces both the initial cost of installing ultraviolet lights 32 and the maintenance cost of periodically replacing the ultraviolet lights 32. The band of wavelengths for performing the germicidal irradiation includes the band of wavelengths necessary to maintain the photocatalytic process.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A fluid purification system comprising:
a fluid handling component;
a substrate;
a photocatalyst on at least one surface of the substrate; and
an ultraviolet light source directing ultraviolet light onto at least one surface of the fluid handling component and on the photocatalyst on the at least one surface of the substrate.

2. The fluid purification system of claim 1 wherein the at least one surface of the fluid handling component and the at least one surface of the substrate are in a fluid flow channel of the fluid purification system.

3. The fluid purification system of claim 2 wherein the ultraviolet light source is downstream of the fluid handling component.

4. The fluid purification system of claim 3 wherein the substrate is downstream of the ultraviolet light source.

5. The fluid purification system of claim 4 wherein the fluid handling component is an evaporator coil.

6. The fluid purification system of claim 1 wherein the fluid handling component is an evaporator coil.

7. The fluid purification system of claim 1 wherein the fluid handling component is a drain pan for an evaporator coil.

8. The fluid purification system of claim 1 wherein the ultraviolet light source is one of a plurality of ultraviolet light sources.

9. The fluid purification system of claim 1 installed in an HVAC system.

10. An air handling system comprising:
a heat transfer element in an air flow channel;
a photocatalyst on at least one surface in the air flow channel; and
an ultraviolet light source directing ultraviolet light onto the heat transfer element and on the photocatalyst on the at least one surface.

11. The air handling system of claim 10 further including a substrate onto which the photocatalyst is supported.

12. The air handling system of claim 10 wherein the heat transfer element is an evaporator coil.

13. The air handling system of claim 10 wherein the ultraviolet light is positioned at least substantially between the heat transfer element and the photocatalyst.

14. The air handling system of claim 10 further including a drain pan below the heat transfer element, the ultraviolet light source directing ultraviolet light onto at least a portion of an interior of the drain pan.

15. The air handling system of claim 10 wherein the photocatalyst is supported on a honeycomb substrate.
